(19) United States
(12) Patent Application Publication
(10) Pub. No.: US 2018/0238163 A1
(43) Pub. Date: Aug. 23, 2018

(54) APPARATUS AND METHOD FOR ESTIMATING AND FOR CONTROLLING A ROTARY SPEED OF A DRILL BIT

(71) Applicant: JELEC, INC., Houston, TX (US)

(72) Inventors: Diemer Anda Ondo, Orvault (FR); Sofien Kerkeni, Nantes (FR)

(73) Assignee: JELEC, INC., Houston, TX (US)

(21) Appl. No.: 15/439,694

(22) Filed: Feb. 22, 2017

(51) Int. Cl. E21B 44/00; E21B 3/02; E21B 41/00; G05B 17/02; G06F 17/16; G06F 17/12

(52) U.S. Cl. CPC E21B 44/00; E21B 3/02; G06F 17/12; G05B 17/02; G06F 17/16; E21B 41/0092

(57) ABSTRACT

Apparatus and method for estimating and for controlling a rotary speed of a drill bit disposed at a distal end of a drillstring. One method comprises identifying one or more parameters of a lumped one-degree-of-freedom (1DOF) model which accounted for one or more well parameters and drillstring parameters, linearizing the lumped 1DOF model for a desired state, wherein a discrete state space model and an associated output are defined using a discrete equation, calculating an estimated rotary speed of the drill bit by applying a predict step and an update step to the linearized lumped 1DOF model, providing a controller input representing a difference between a desired rotary speed and the estimated rotary speed of the drill bit to a polynomial controller designed based on the lumped 1DOF model, and adjusting the rotary speed of the drill bit utilizing the polynomial controller based on the controller input.

### FIELD OF THE INVENTION

The present invention generally relates to a method for drilling a borehole and to a drilling mechanism and an electronic controller utilized in drilling a borehole. More particularly, the present invention relates to a method for damping stick-slip oscillation in a drill string and to a method for estimating and for controlling the instantaneous rotational speed of a bottom hole assembly.

### BACKGROUND

In oil and gas exploration, a drilling process is utilized to reach an oil and/or gas formation in the earth. The location of the drilling site can either be on dry land utilizing a land rig or on the ocean utilizing an offshore rig. In the offshore activity, several configurations exist, such as FPSO (Floating Production, Storage and Offloading), FPDSO (Floating Production, Drilling, Storage and Off-Loading), Jack Up, etc. Drilling an oil and/or gas well involves the creation of a borehole of considerable length utilizing a drill bit which is in direct contact with the soil at the end of the borehole. As the drill bit is advanced through the soil, drill pipes are added behind the drill bit to form the drillstring. The whole drillstring is turned by a drilling mechanism at the surface, which in turn rotates the drill bit to extend the borehole. The drilling mechanism is typically a top drive or rotary table, each of which may comprise a heavy flywheel connected to the top of the drillstring.

The drillstring is an extremely slender structure relative to the length of the borehole, and during drilling the string is twisted several turns because of the resistant torque on the bit. Simultaneous measurements of drilling rotation at the surface and at the bit have revealed that the drillstring often behaves as a torsional pendulum, i.e., the top of the drillstring rotates with a constant angular velocity whereas the drill bit performs a rotation with varying angular velocity comprising a constant part and a superimposed torsional vibration. In extreme cases, the torsional part becomes so large that the drill bit periodically comes to a complete standstill, during which the drillstring is torqued-up until the drill bit suddenly rotates again at an angular velocity that can be many times higher than the angular velocity measured at the surface. This phenomenon is generally known as stick-slip.

The stick-slip phenomenon has been studied for more than two decades and is recognized as a major problem when drilling a well. It is responsible for reducing drill bit useable life and for reducing the rate of penetration, which results in longer time needed for drilling until reaching the oil/gas formation. Many have attempted to find a solution to address this problem. Some suggest utilizing operational means such as adding friction reducers to the mud and changing the rotation speed or the weight on bit. However, these remedies are not completely effective and are extremely dependent on the knowledge of the operating technicians. Some suggest utilizing a smart control at the top drive to mitigate the stick-slip phenomenon. As an example of a smart control, a torque feedback from a dedicated string torque sensor is utilized to reduce the stick-slip phenomenon. More recently, a Proportional-Integral-Derivative (PID) controller has been proposed to stabilise the rotary speed of the drill bit. However, the PID controller is not sufficiently robust to respond to parameters variations (e.g., weight on drill bit, length of drillstring, change of desired velocity at the top drive, etc.) during drilling and needs to be rescaled accordingly. Therefore, there remains a need for a solution to address the stick-slip phenomenon.

### SUMMARY

One embodiment of the invention provides a method for estimating a rotary speed of a drill bit disposed at a distal end of a drillstring which is rotated mechanically from surface. The method comprises identifying one or more parameters of a lumped one degree of freedom (1DOF) model which accounted for one or more well parameters and drillstring parameters, linearizing the lumped 1DOF model for a desired state, wherein a discrete state space model and an associated output are defined using a discrete equation, and calculating the rotary speed of the drill bit by applying a predict step and an update step to the linearized lumped 1DOF model.

Another embodiment of the invention provides another method for estimating a rotary speed of a drill bit disposed at a distal end of a drillstring which is rotated mechanically from surface. The method comprises identifying one or more parameters of a lumped one degree of freedom (1DOF) model which accounted for one or more well parameters and drillstring parameters, and applying a filter to the lumped 1DOF model and an associated output, wherein the rotary speed of the drill bit is calculated by repeating a predict step and an update step to the lumped 1DOF model at each time iteration. The filter may be any one of the following: a Linearized Kalman Filter (KF), an Extended Kalman Filter (EKF), a Cubature Kalman Filter (CKF) and an Unscented Kalman Filter (UKF).

Another embodiment of the invention provides a method for controlling a rotary speed of a drill bit disposed at a distal end of a drillstring which is rotated mechanically from surface. The method comprises identifying one or more parameters of a lumped one degree of freedom (1DOF) model which accounted for one or more well parameters and drillstring parameters, linearizing the lumped 1DOF model for a desired state, wherein a discrete state space model and an associated output are defined using a discrete equation, calculating an estimated rotary speed of the drill bit by applying a predict step and an update step to the linearized lumped 1DOF model, providing a controller input representing a difference between a desired rotary speed and the estimated rotary speed of the drill bit to a controller, wherein the controller comprises a polynomial controller designed based on the lumped 1DOF model, and adjusting the rotary speed of the drill bit utilizing the polynomial controller based on the controller input. In one embodiment, the polynomial controller is a H_{∞} controller.

Another embodiment of the invention provides another method for controlling a rotary speed of a drill bit disposed at a distal end of a drillstring which is rotated mechanically from surface. The method comprises identifying one or more parameters of a lumped one degree of freedom (1DOF) model which accounted for one or more well parameters and drillstring parameters, applying a filter to the lumped 1DOF model and an associated output, wherein an estimated rotary speed of the drill bit is calculated by repeating a predict step and an update step to the lumped 1DOF model at each time iteration, providing a controller input representing a difference between a desired rotary speed and the estimated rotary speed of the drill bit to a controller, wherein the controller comprises a H_{∞} controller designed based on the lumped 1DOF model, and adjusting the rotary speed of the drill bit utilizing the H_{∞} controller based on the controller input. The filter may be one of: a Linearized Kalman Filter (KF), an Extended Kalman Filter (EKF), a Cubature Kalman Filter (CKF) and an Unscented Kalman Filter (UKF). The H_{∞} controller may be designed utilizing weighted functions defined to take into account modelling of a variable frequency drive (VFD) disposed to mechanically rotate the drillstring. The H_{∞} controller may be further configured to automatically modify and tune control coefficients including gains, weighted functions and well parameters.

Another embodiment of the invention provides an apparatus for controlling a rotary speed of a drill bit disposed at a distal end of a drillstring which is rotated mechanically from surface, the apparatus comprising a programmable logic controller configured to linearize a lumped one degree of freedom (1DOF) model which accounted for one or more well parameters and drillstring parameters for a desired state, wherein a discrete state space model and an associated output are defined using a discrete equation, calculate an estimated rotary speed of the drill bit by applying a predict step and an update step to the linearized lumped 1DOF model, provide a controller input representing a difference between a desired rotary speed and the estimated rotary speed of the drill bit to a controller, wherein the controller comprises a polynomial controller designed based on the lumped 1DOF model, and adjust the rotary speed of the drill bit utilizing the polynomial controller based on the controller input. The polynomial controller may comprise a H_{∞} controller.

Another embodiment of the invention provides an apparatus for controlling a rotary speed of a drill bit disposed at a distal end of a drillstring which is rotated mechanically from surface, the apparatus comprising a programmable logic controller configured to apply a filter to a lumped one degree of freedom (1DOF) model which accounted for one or more well parameters and drillstring parameters and to an associated output, wherein an estimated rotary speed of the drill bit is calculated by repeating a predict step and an update step to the lumped 1DOF model at each time iteration, provide a controller input representing a difference between a desired rotary speed and the estimated rotary speed of the drill bit to a H_{∞} controller designed based on the lumped 1DOF model, and adjust the rotary speed of the drill bit utilizing the H_{∞} controller based on the controller input. The filter may comprise one of: a Linearized Kalman Filter (KF), an Extended Kalman Filter (EKF), a Cubature Kalman Filter (CKF) and an Unscented Kalman Filter (UKF). The H_{∞} controller may be designed utilizing weighted functions defined to consider modelling of a variable frequency drive (VFD) disposed to mechanically rotate the drillstring. The H_{∞} controller may be further configured to automatically modify and tune control coefficients including gains, weighted functions and well parameters.

### BRIEF DESCRIPTION OF THE DRAWINGS

FIG. 1 is a schematic view of a drilling rig 10 including a controller 30 for reducing or dampening the stick-slip phenomenon according to one embodiment of the present invention.

FIG. 2 is a component view of a controller 30 according to one embodiment of the present invention.

FIG. 3 is a schematic diagram for a design of a H_{∞} control to be used in the speed controller 130 according to one embodiment of the present invention.

FIG. 4 is a schematic diagram of a Programmable Logic Controller (PLC) 120 according to one embodiment of the present invention.

FIGS. 5A-5C are graphical illustrations showing the rotary speed of the drill bit and the torque at the surface as simulation results of a controller 30 according to one embodiment of the present invention.

FIGS. 6A-6E are graphical illustrations showing the estimation and control of rotary speed of the drill bit and the torque at the surface as simulation results of a controller 30 according to another embodiment of the present invention.

### DETAILED DESCRIPTION OF THE INVENTION

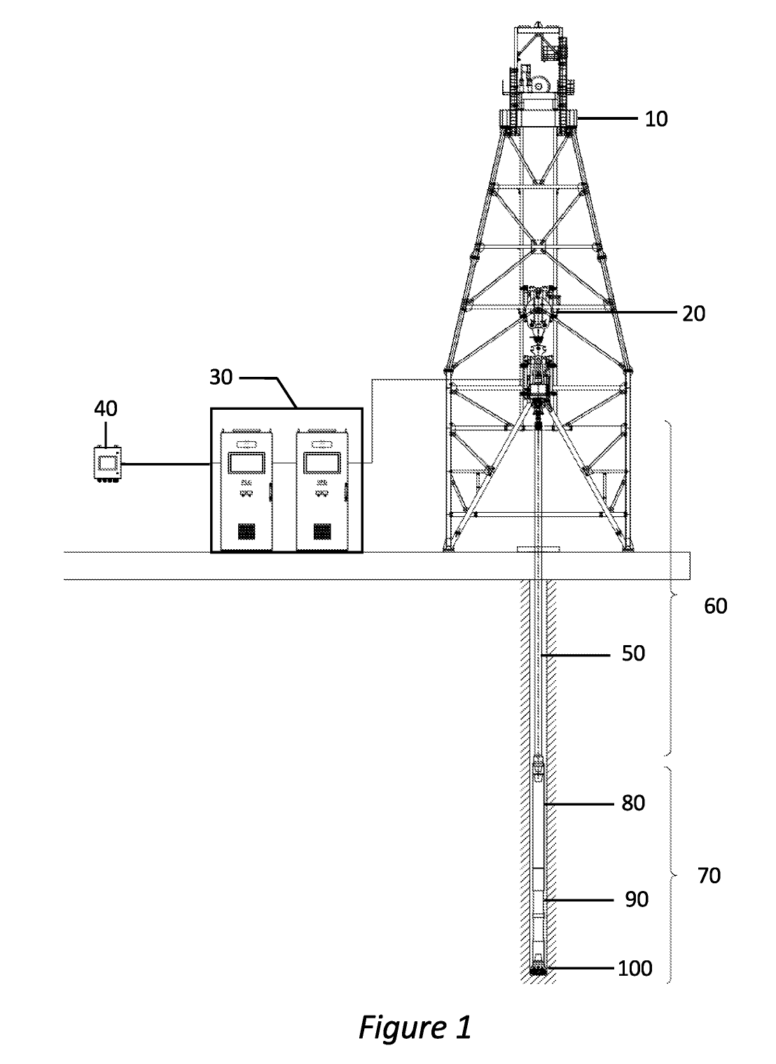

FIG. 1 is a schematic view of a drilling rig 10 including a controller 30 for reducing or dampening the stick-slip phenomenon according to one embodiment of the present invention. Referring to FIG. 1, a drilling rig 10 controls drilling operations using a drillstring 60 comprising a plurality of drill pipes 50 that are connected together end to end. The drilling rig 10 can be designed to be utilized for production of any kind of resources (e.g., oil, gas, mineral, etc.) or for any kind of support (e.g., land, offshore, floating, mobile, etc.). A typical drillstring may have a length of several kilometres, and a drill bit 100 is disposed at the lower or distal end of the drillstring 60 as part of a Bottom Hole Assembly (BHA) 70. The BHA 70 may also include a transmitter Measurement-While-Drilling (MWD) unit 80, centralizers, stabilizers (not represented here) and a drill collar 90 or a heavy weight drill pipe which precede the drill bit 100. The drilling rig 10 includes a top drive system 20 to rotate the drillstring 60 and the drill bit 100. Other mechanical devices, such as a rotary table, may be utilized to rotate the drill bit through the drillstring. Embodiments of the invention may be utilized for vertical, horizontal and directional drilling.

Drilling information and data are displayed on a human interface console 40 which may comprise an interface for human to machine (HMI) designed such that a human operator may provide information to and access information from the controller 30 (i.e., activate/deactivate the controller, set desired velocity, set the characteristic of the well or those of the drillstring, etc.). The console 40 is communicably connected to the controller 30 which is communicably connected to the top drive system 20 and the components of the BHA 70.

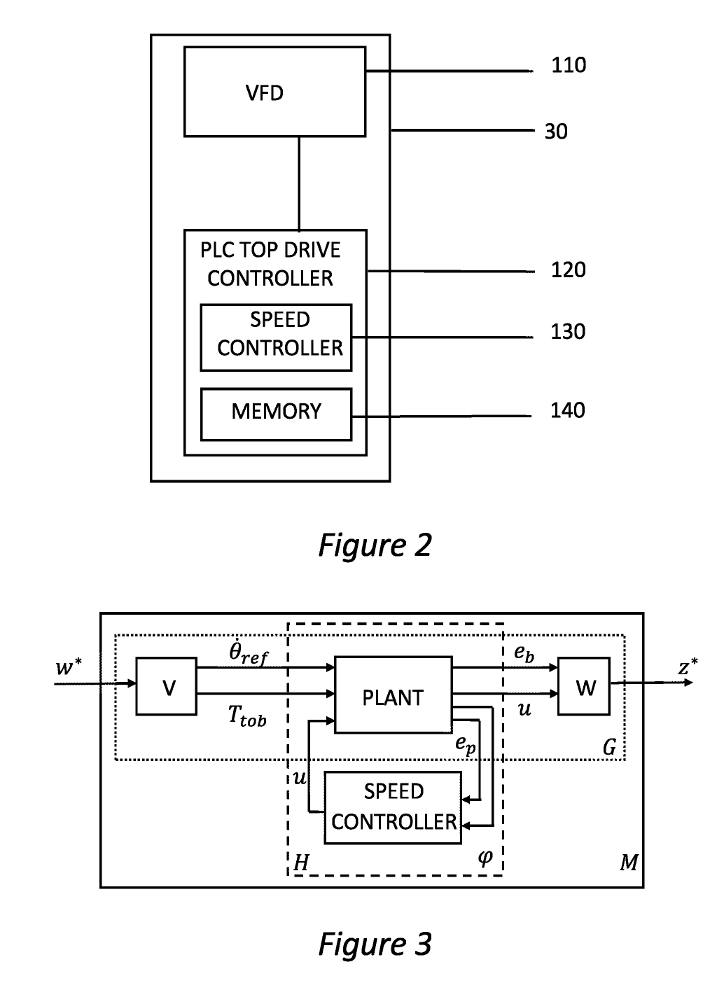

FIG. 2 is a component view of a controller 30 according to one embodiment of the present invention. The controller 30 may comprise a variable frequency drive (VFD) 110 and digital programmable logic controller (PLC) 120. In one embodiment, the PLC 120 comprises a speed controller 130 and a memory 140 to store data and execute machine instructions. The memory 140 contained in the digital PLC 120 may comprise flash memory containing executable machine instructions which utilizes an H_{∞} controller which is implemented in the speed controller 130. The PLC 120 may be communicably connected to share data with the human interface console 40, with the VFD 110 and with the top drive system 20. In an alternative embodiment, the VFD 110 may be incorporated into the top drive system 20.

Aspects of the present invention are based on knowledge of techniques for modelling the behaviour of a drillstring in a borehole. In particular, using any drilling data handbook, it is possible to represent most drillstring as a lumped two degree of freedom (2DOF) model representing the dynamics of the part of the drillstring connected to the top drive or rotary table and the part comprising the bottom hole assembly (BHA). The drillstring may be modelled using a lumped 2DOF model as presented below. The first equation represents the dynamics of the rotary speed of the top drive, and the second equation represents the dynamics of the rotary speed of the drill bit.

Jₚ∂ₜₜθₚ(t)+c(θₜθₚ(t)−∂ₜθ_{b}(t))+k(θₚ(t)−θ_{b}(t))=Tₘ−T_{fp}(∂ₜθₚ(t))

J_{b}∂ₜₜθ_{b}(t)−c(∂ₜθₚ(t)−∂ₜθ_{b}(t))−k(θₚ(t)−θ_{b}(t))=−T_{fb}(∂ₜθ_{b}(t))

wherein

θₚ and θ_{b} are the angular position at the surface and at the drill bit, respectively;

Tₘ is the torque of the drillstring at the surface;

Jₚ and J_{b} are the corresponding inertia of the drillstring and the BHA, respectively;

T_{fp} and T_{fb} are the corresponding friction torque associate to Jₚ and J_{b}, respectively;

c is the torsional damping coefficient; and

k is the torsional stiffness coefficient.

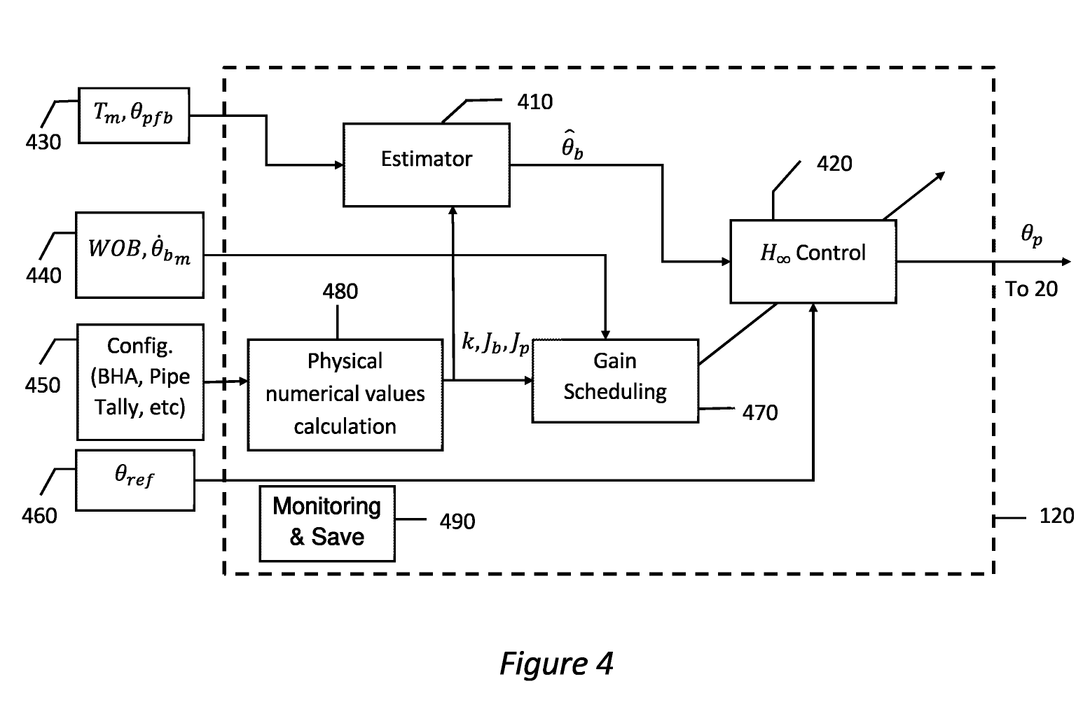

FIG. 3 is a schematic diagram for a design of a H_{∞} control to be used in the speed controller 130 according to one embodiment of the present invention. As shown in FIG. 3, G represents the generalized plant (or a non-linear system), and H is designed as a nominal closed loop while M represents the generalized closed loop system.

In one embodiment of the present invention, the controller may be designed using the following steps:

Choose the output y as a vector given by eₚ=∂ₜθ_{ref}−∂ₜθₚ and φ;

Determinate the weighted functions V and W given as diagonal matrices:

$$V = [ \begin{matrix}{V}_{1} ( s ) & 0 \\ 0 & {V}_{s} ( s )\end{matrix} ]$$

$$W = [ \begin{matrix}{W}_{1} ( s ) & 0 \\ 0 & {W}_{2} ( s )\end{matrix} ]$$

where transfer functions Vᵢ(s) and Wᵢ(s) may be designed according to embodiments of the invention.

In one embodiment, the controller may be designed using the previous steps in which the output y is chosen as the difference of rotary speed ∂ₜθ_{ref}−∂ₜθ_{b}, i.e., the difference between the desired and the BHA rotary speed.

In one embodiment, the controller may be designed defining V₂(s) as a number to ensure that the controller has good abilities against disturbance.

In one embodiment, the controller may be designed defining V₁(s) as a combination of a number in series with a transfer function modelling a filter or a system, as for example a VFD, or any other combination.

One embodiment of the present invention provides a method of estimating the rotary speed of the drill bit at the lower end of a drill string which is rotated by mechanical means at the surface using a drill pipe, said method is designed from a lumped 1DOF model and the input of the filter/observer is the torque of the drill string at the surface. In one embodiment, the method comprises the following steps:
modelling the internal dynamic using as state vector

x^{T}=[e_{b}φ]^{T}

that is

∂ₜx=f(x(t),u(t));
express the torque of the drill string at the surface as a function of the rotary speed at the surface, at the BHA and their derivatives, that is

y(t)=h(x(t),u(t))

where u(t) represents the rotary speed at the surface.

In one embodiment, the rotary speed of the drill bit may be estimated utilizing a filter. The filter may be a linearized Kalman filter which comprises the steps:

linearize functions f(x(t),u(t)) and h(x(t),u(t)) about the desired state (x̅, ū);

rewrite the system as

∂ₜx(t)=Fx(t)+f₀+W₀

y(t)=H x(t)+h₀+V₀

with

F=∂ₓf(x,u)_{x̅,ū}

f₀=f(x̅,ū)−∂ₓf(x,u)_{x̅,ū}x̅−∂ᵤf(x,u)_{x̅,ū}(u−ū)

H=∂ₓh(x,u)_{x̅,ū}

h₀=h(x̅,ū)−∂ₓh(x,u)_{x̅,ū}x̅−∂ᵤh(x,u)_{x̅,ū}(u−ū)

apply the usual steps of a Kalman filter (predict and update steps).

In one embodiment, the filter may also need a step of discretization of functions F, H, f₀ and h₀.

In one embodiment, the rotary speed of the drill bit may be estimated utilizing an extended Kalman filter (EKF) which is applied on the lumped 1DOF model.

In one embodiment, the rotary speed of the drill bit may be estimated utilizing any Kalman filter, high gain filter/observer or a Luenberger's observer, wherein the filter is applied on the lumped 1DOF model.

In accord with some aspects of the present invention, a software program may be provided to design the estimator separately of a software which performs only the estimation. The software program allowing the design of an estimator may be provided as an upgrade of the software program which performs the estimation of the rotary speed of the drill bit.

Another aspect of the present invention provides a controlling system for the stability of the rotary speed of the drill bit rotated at the surface by mechanical means using a drillstring. The controlling system includes a calculating unit comprising a H_{∞} controller designed according to embodiments of the present invention.

Another aspect of the present invention provides an electronic controller to be used in a mechanical system of drilling. The electronic controller includes a H_{∞} controller designed according to embodiments of the present invention and memory (e.g., flash memory) containing executable machine instructions to scale the controller depending of the characteristics of the well.

Another aspect of the present invention provides a method for reducing/damping the oscillations of the rotary speed of the drill bit appearing during the stick-slip phenomenon, the method comprising:
reducing/damping stick-slip oscillations using a drilling mechanism at the top of the drill string; and
controlling the rotary speed of said drill string using a H_{∞} controller which is characterized by the steps of:
   measuring/estimating the difference between the desired rotary speed and the rotary speed of the drill bit; and
   determining the updated input using the controller.

One embodiment of the present invention provides a method for controlling the stability of the rotary speed of the drill bit at the lower end of the drillstring utilizing a lumped one-degree-of-freedom (1DOF) model, assuming the speed rotation of the drillstring at the surface is well regulated, using for example a VFD. In one embodiment, a variation of the rotary speed at the surface is defined as a function of the difference between the rotary speed of the drill bit and the desired rotary speed. The variation of the rotary speed at the surface is determinate using an H_{∞} controller designed from a lumped 1DOF model defined as follows:

J_{b}∂ₜₜθ_{b}(t)−c(θₜθₚ(t)−∂ₜθ_{b}(t))−k(θₚ(t)−θ_{b}(t))=−T_{fb}(∂ₜθ_{b}(t))

where θₜ is the time derivative,

θₚ is the angular position at the surface,

θ_{b} is the angular position at the lower end,

c is the torsional damping coefficient,

k is the torsional stiffness coefficient, and

T_{fb} is the torque at the BHA, which can be given as a function of the rotary speed of the drill bit.

Using said lumped 1DOF model, the problem to be solved is stated as

∂ₜx(t)=Ax(t)+B₁w(t)+B₂u(t)

z(t)=C₁x(t)+D₁₁w(t)+D₁₂u(t)

y(t)=C₂x(t)+D₂₁w(t)+D₂₂u(t)

with

x^{T}=[∂ₜθ_{b}, φ]^{T}, where φ=θₚ−θ_{b};

z^{T}=[e_{b}, u]^{T}, where e_{b}=θₜθ_{ref}−∂ₜθ_{b};

y is the output, which will be given depending of the method;

w^{T}=[θₜθ_{ref}, T_{tob}]; where T_{tob} is the nonlinear part of the torque at the BHA. The definition of the matrices is straightforward once the output is specified.

In one embodiment, the rotary speed at the surface is utilized as the control, i.e., its dynamics are no longer given by an equation of the lumped model. With just one equation remaining, the lumped 1DOF model is represented by:

J_{b}∂ₜₜθ_{b}(t)−c(∂ₜθₚ(t)−∂ₜθ_{b}(t))−k(θₚ(t)−θ_{b}(t))=−T_{fb}(∂ₜθ_{b}(t))

where ∂ₜθₚ is seen as the control of the system. Using the above equation, the system may be formulated as a state space model, and the H_{∞} problem to be solved (which may be determined from FIG. 3) is as follows:

∂ₜx(t)=Ax(t)+B₁w(t)+B₂u(t)

z(t)=C₁x(t)+D₁₁w(t)+D₁₂u(t)

y(t)=C₂x(t)+D₂₁w(t)+D₂₂u(t)

with

x^{T}=[∂ₜθ_{b}, φ]T, where φ=θₚ−θ_{b};

z^{T}=[e_{b}, u]^{T}, where e_{b}=θₜθ_{ref}−∂ₜθ_{b};

y=e_{b};

w^{T}=[∂ᵣθ_{ref}, T_{tob}], where T_{tob}=W_{ob}R_{b}(μ_{cb}+(μ_{sb}−μ_{cb})e^{-γ}^{_{b}}^{|∂}^{ₜ}^{θ}^{_{b}}^{(t)|})sign(∂ₜθ_{b}). The matrices are given by

$$A = [ \begin{matrix}- \frac{c + {d}_{b}}{{J}_{b}} & \frac{k}{{J}_{b}} \\ - 1 & 0\end{matrix} ] , {B}_{1} = [ \begin{matrix}\frac{c}{{J}_{b}} & - \frac{1}{{J}_{b}} \\ 1 & 0\end{matrix} ] , {B}_{2} = [ \begin{matrix}\frac{c}{{J}_{b}} \\ 1\end{matrix} ]$$

$${C}_{1} = [ \begin{matrix}- 1 & 0 \\ 0 & 0\end{matrix} ] , {D}_{11} = [ \begin{matrix}1 & 0 \\ 0 & 0\end{matrix} ] , {D}_{12} = [ \begin{matrix}0 \\ 1\end{matrix} ]$$

$${C}_{2} = [ \begin{matrix}- 1 & 0\end{matrix} ] , {D}_{21} = [ \begin{matrix}1 & 0\end{matrix} ] , {D}_{22} = 0.$$

The weighted functions may be chosen as specified by a method according to one embodiment of the invention, that is:

$$V = [ \begin{matrix}1 & 0 \\ 0 & {10}^{3}\end{matrix} ] , W = [ \begin{matrix}\frac{s + 0.85}{1.7 s + 8.5 * {10}^{- 5}} & 0 \\ 0 & {2.10}^{3} \frac{s + 0.05}{s + {3.10}^{3}}\end{matrix} ] .$$

Solving the H_{∞} problem as presented on FIG. 3 with defined matrices and weighted functions lead to the design of an H_{∞} controller. Depending of the utilized solver, some of the previous matrices may need to be modified to ensure the observability/controllability of the problem.

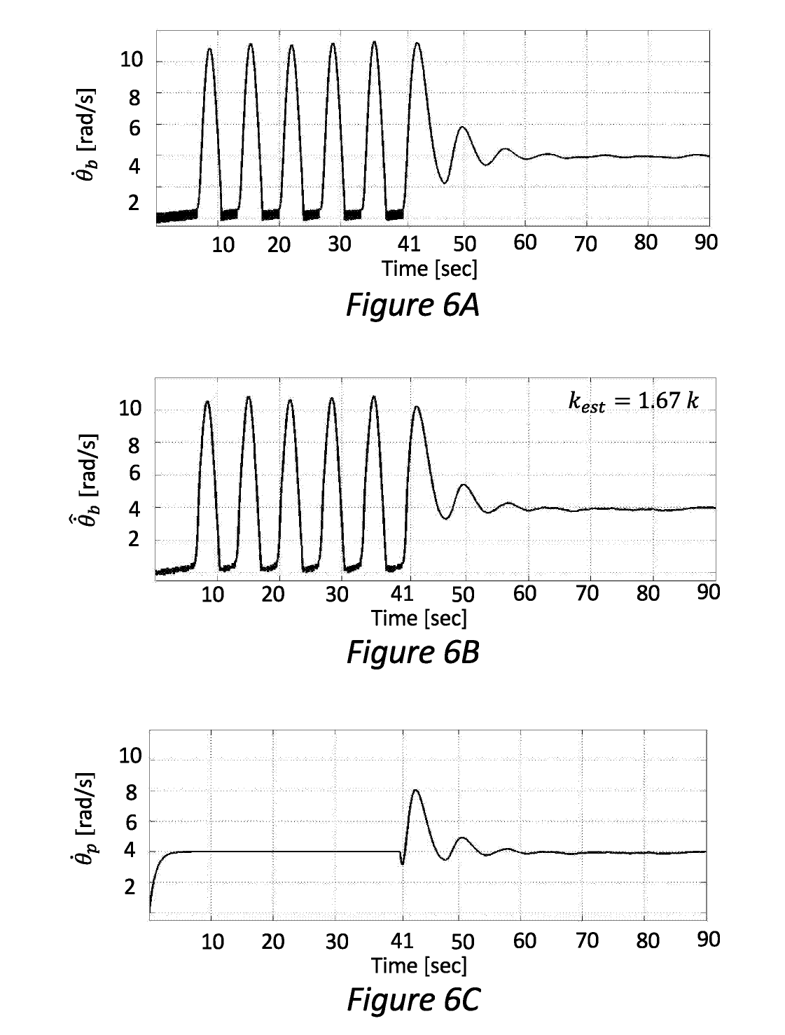

The controller uses as input the difference between the desired rotary speed and the rotary speed of the drill bit. When apply it to the previous model on a realistic model (from data of a drilling data handbook), see Table 1, the results obtained are as provided in FIGS. 5A, 5B and 5C. FIG. 5A shows the rotary speed of the bit. FIG. 5B shows the top drive rotary speed, wherein the controller is turned on around 41 s. FIG. 5C shows the variation of the torque at the surface.

However, the rotary speed of the drill bit may be not always directly measurable, and a filter may be utilized to estimate the rotary speed of the drill bit. In accord with some aspects of the present invention, the rotary speed of the drill bit may be estimated. In one embodiment, a tuning of a filter may be utilized to estimate the rotary speed of the drill bit. The following example utilizes a Cubature Kalman Filter (CKF) to estimate the rotary speed of the drill bit.

Defining the state vector x(t)=[∂ₜθ_{b} φ]^{T}, functions f(x,u) and h(x,u) are given by

$$f ( x , u ) = ( \begin{matrix}\frac{1}{{J}_{b}} ( k ( \int u - {θ}_{b} ) - ( c + {d}_{b} ) {\partial }_{t} {θ}_{b} + cu - {T}_{tob} ) \\ u - {\partial }_{t} {θ}_{b}\end{matrix} )$$

$$h ( x , u ) = k ( \int u - {θ}_{b} ) - c {\partial }_{t} {θ}_{b} + ( c + {d}_{p} ) u + {J}_{p} {\partial }_{t} u .$$

A discretization of those functions is done using an explicit Euler method, that is, by letting

∂ₜx(t)=f(x(t),u(t))

y(t)=h(x(t),u(t)),

which lead to

xₖ=xₖ₋₁+dt*f(xₖ₋₁,uₖ₋₁)=f_{d}(xₖ₋₁,uₖ₋₁)

yₖ=h(xₖ,uₖ)=h_{d}(xₖ,uₖ).

The steps of the filter are:

Predict:

$$The set of vector {σ}_{i} = \{ \begin{matrix}\sqrt{2} {e}_{i} , & i = 1 , 2 \\ - \sqrt{2} {e}_{i - 2} , & i = 3 , 4\end{matrix}$$

where eᵢ represents the i^{th} vector column of a basis in [symbol] ²

$${x}_{k - 1}^{( i )} = \sqrt{{P}_{k - 1}} {σ}_{i} + {m}_{k - 1}$$

$${\hat{x}}_{k}^{- ( i )} = {f}_{d} ( {x}_{k - 1}^{( i )} , {u}_{k} )$$

$${m}_{k}^{-} = \frac{1}{2 n} {\sum }_{i} {\hat{x}}_{k}^{- ( i )}$$

$${P}_{k}^{-} = \frac{1}{2 n} {\sum }_{i} {{\hat{x}}_{k}^{- ( i )} ( {\hat{x}}_{k}^{- ( i )} )}^{T} - {{m}_{k}^{-} ( {m}_{k}^{-} )}^{T} + {Q}_{k}^{w}$$

Update:

$${x}_{k}^{- ( i )} = \sqrt{{P}_{k}^{-}} {σ}_{i} + {m}_{k}^{-}$$

$${Y}_{k}^{- ( i )} = {h}_{d} ( {x}_{k}^{- ( i )} , {u}_{k} )$$

$${\hat{y}}_{k} = \frac{1}{2 n} {\sum }_{i} {Y}_{k}^{- ( i )}$$

$${S}_{k} = \frac{1}{2 n} {\sum }_{i} {{Y}_{k}^{- ( i )} ( {Y}_{k}^{- ( i )} )}^{T} - {{\hat{y}}_{k}^{-} ( {\hat{y}}_{k}^{-} )}^{T} + {Q}_{k}^{v}$$

$${C}_{k} = \frac{1}{2 n} {\sum }_{i} {{x}_{k}^{- ( i )} ( {Y}_{k}^{- ( i )} )}^{T} - {{m}_{k}^{-} ( {\hat{y}}_{k}^{-} )}^{T}$$

$${K}_{k} = {C}_{k} {S}_{k}$$

$${m}_{k} = {m}_{k}^{-} + {K}_{k} ( {y}_{k} - {\hat{y}}_{k} )$$

$${P}_{k} = {P}_{k}^{-} - {K}_{k} {S}_{k} {K}_{k}^{T} .$$

The filter is initialized using

$${P}_{0} = [ \begin{matrix}\frac{1}{{\partial }_{t} {θ}_{ref}^{2}} & 0 \\ 0 & \frac{1}{{ϵ}^{2}}\end{matrix} ] , ϵ ≃ mean ( ϕ )$$

$$and$$

$${m}_{0} = {x}_{0} .$$

Matrices Qₖ^{w} and Qₖ^{v} are given as function of the confidence determined in the model and the error (bias) of measurement observed, respectively. In one embodiment of the present invention, they can be given by

$${Q}_{k}^{v} = 4 e 4 , {Q}_{k}^{w} = [ \begin{matrix}1 e - 3 & 0 \\ 0 & 1 e - 3\end{matrix} ] .$$

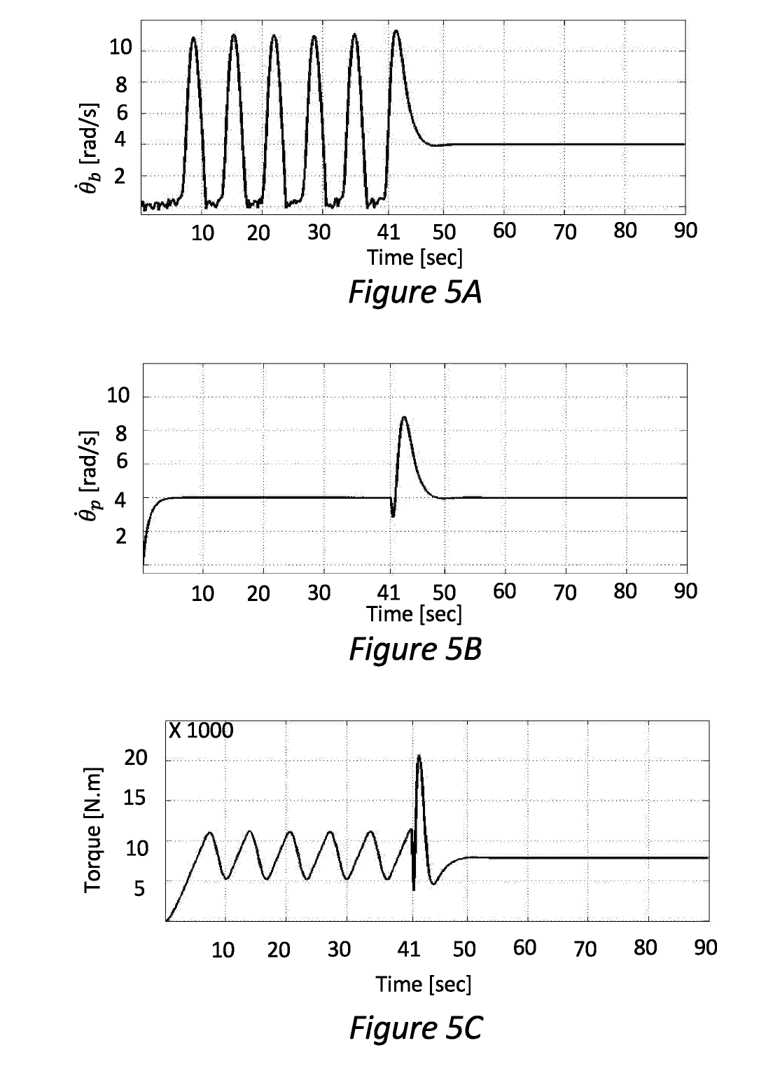

FIG. 4 is a schematic diagram of a Programmable Logic Controller (PLC) 120 according to one embodiment of the present invention. The PLC 120 includes an estimator 410 and a H_{∞} controller 420 defined by embodiments of the present invention. As shown in one embodiment, the H_{∞} controller 420 and estimator 410 of the present invention may be utilized together and be implemented in the PLC.

In one embodiment, FIG. 4 represents the general functioning architecture of the algorithms and implementation of an estimator embedded in the controller 30 as represented on FIGS. 1 and 2. In one embodiment, all input signals required for the controller 30, such as Torque Feedback from VFD (input 430) or Weight On Bit (input 440) from Drilling instrumentation are fed to the controller. The configuration of the drillstring (input 450) is also an input of the system and is provided to the physical numerical values calculation module 480. The configuration input may be obtained directly from the human/user interface of the controller 30 via input by an operator, or obtained from another device and/or automatically. Depending the actual configuration and the measurements, the coefficients of the estimator (input 450), for example the stiffness, the diameter of the Drillbit, the Weight on the Bit, the inertia of the BHA and of the Top Drive, etc., may change accordingly. The reference speed (\dot{θ}_{ref}) 460 is also provided to the H_{∞} controller 420.

Depending on these parameters and the top drive characteristics, the Gain Scheduling 470 selects the appropriate gains and numerical values of the H_{∞} controller 420 and the tuned control parameters including the tuning filters V and W (referring back to FIG. 3). The gains may be computed online or may be computed offline and set up or programmed in the memory of the PLC 120. The required top drive velocity for eliminating stick-slip oscillations (output of the H_{∞} controller 420) is provided to the top drive system 20 or the PLC of the top drive.

In one embodiment, a monitoring and save module 490 may be provided to monitor the functioning of the controller 30. For example, an estimation monitoring may be utilized to prevent failures in the estimation or bad numerical values computations such as underflows or overflows. The monitoring and save module 490 may also provide the function for saving the internal states of the estimator 410 and the H_{∞} controller 420 and may be utilized to back-up the data.

FIGS. 5A to 5C show the results obtained from the simulation when the controller is activated when a measure (using for example MWD) of the rotary speed of the bit is provided.

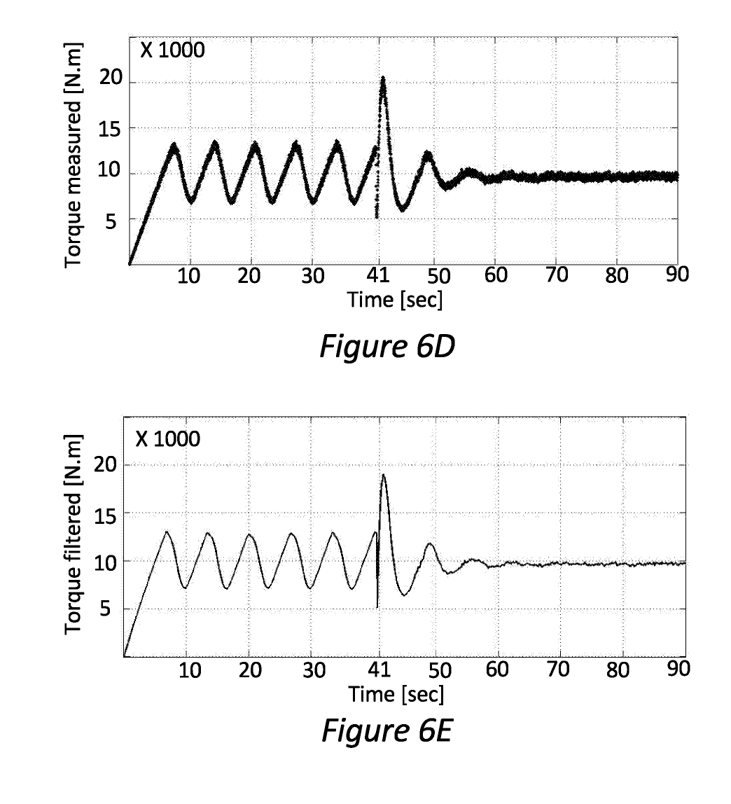

FIGS. 6A to 6E show the results obtained from the simulation when the controller and estimator are utilized according to one embodiment of the present invention. In this example, a perturbed model is utilized for the estimator, i.e., a torsional stiffness kₑₛₜ=1.67 kₙₒₘᵢₙₐₗ. FIG. 6A shows the rotary speed of the drill bit (from the plant). FIG. 6B shows the estimated rotary speed at the bit. FIG. 6C is the rotary speed at the top drive. FIG. 6D shows the measured torque (with bias), and FIG. 6E shows the filtered torque. In one embodiment, the same parameters were considered, but the stiffness coefficient was changed as it was observed as the one parameter that has real effect on the controller. With a value of k=1.67 kₙₒₘᵢₙₐₗ, the stability of the rotary speed at the drill bit is ensured. The same observation may be done with 0.6 kₙₒₘᵢₙₐₗ≤k≤1.67Kₙₒₘᵢₙₐₗ.

The set of the parameters and characteristics of the drill string is given by the following table.

TABLE 1

| Parameter | Value (unit) |
|---|---|
| Jₚ | 2122 (Kg · m²) |
| J_{b} | 374 (Kg · m²) |
| c | 23.2 (N · m · s/rad) |
| k | 473 (N · m/rad) |
| dₚ | 425 (N · m · s/rad) |
| d_{b} | 50 (N · m · s/rad) |
| μ_{cb} | 0.5 |
| μ_{sb} | 0.8 |
| γ_{b} | 0.9 |
| W_{ob} | 1000 (*Gravity) |
| R_{b} | 0.155575 (m) |

While the foregoing is directed to embodiments of the present invention, it will be obvious to those of ordinary skills in the art that other and further embodiments of the invention may be devised without departing from the basic scope thereof, and the scope thereof is determined by the claims that follow.

1. A method for estimating a rotary speed of a drill bit disposed at a distal end of a drillstring which is rotated mechanically from surface, the method comprising:
identifying one or more parameters of a lumped one degree of freedom (1DOF) model which accounted for one or more well parameters and drillstring parameters;
linearizing the lumped 1DOF model for a desired state, wherein a discrete state space model and an associated output are defined using a discrete equation; and
calculating the rotary speed of the drill bit by applying a predict step and an update step to the linearized lumped 1DOF model.

2. The method of claim 1, wherein the linearization step is operated at each time iteration about the actual estimation of the rotary speed of the drill bit.

3. A method for estimating a rotary speed of a drill bit disposed at a distal end of a drillstring which is rotated mechanically from surface, the method comprising:
identifying one or more parameters of a lumped one degree of freedom (1DOF) model which accounted for one or more well parameters and drillstring parameters; and
applying a filter to the lumped 1DOF model and an associated output, wherein the rotary speed of the drill bit is calculated by repeating a predict step and an update step to the lumped 1DOF model at each time iteration.

4. The method of claim 3, wherein the filter is one of: a Linearized Kalman Filter (KF), an Extended Kalman Filter (EKF), a Cubature Kalman Filter (CKF) and an Unscented Kalman Filter (UKF).

5. A method for controlling a rotary speed of a drill bit disposed at a distal end of a drillstring which is rotated mechanically from surface, the method comprising:
identifying one or more parameters of a lumped one degree of freedom (1DOF) model which accounted for one or more well parameters and drillstring parameters;
linearizing the lumped 1DOF model for a desired state, wherein a discrete state space model and an associated output are defined using a discrete equation;
calculating an estimated rotary speed of the drill bit by applying a predict step and an update step to the linearized lumped 1DOF model;
providing a controller input representing a difference between a desired rotary speed and the estimated rotary speed of the drill bit to a controller, wherein the controller comprises a polynomial controller designed based on the lumped 1DOF model; and
adjusting the rotary speed of the drill bit utilizing the polynomial controller based on the controller input.

6. The method of claim 5, wherein the polynomial controller is a H_{∞} controller.

7. The method of claim 5, wherein the linearization step is operated at each time iteration about the actual estimation of the rotary speed of the drill bit.

8. A method for controlling a rotary speed of a drill bit disposed at a distal end of a drillstring which is rotated mechanically from surface, the method comprising:
identifying one or more parameters of a lumped one degree of freedom (1DOF) model which accounted for one or more well parameters and drillstring parameters;
applying a filter to the lumped 1DOF model and an associated output, wherein an estimated rotary speed of the drill bit is calculated by repeating a predict step and an update step to the lumped 1DOF model at each time iteration;
providing a controller input representing a difference between a desired rotary speed and the estimated rotary speed of the drill bit to a controller, wherein the controller comprises a H_{∞} controller designed based on the lumped 1DOF model; and
adjusting the rotary speed of the drill bit utilizing the H_{∞} controller based on the controller input.

9. The method of claim 8, wherein the filter is one of: a Linearized Kalman Filter (KF), an Extended Kalman Filter (EKF), a Cubature Kalman Filter (CKF) and an Unscented Kalman Filter (UKF).

10. The method of claim 8, wherein the H_{∞} controller is designed utilizing weighted functions defined to consider modelling of a variable frequency drive (VFD) disposed to mechanically rotate the drillstring.

11. The method of claim 8, wherein the H_{∞} controller automatically modifies and tunes control coefficients including gains, weighted functions and well parameters.

12. An apparatus for controlling a rotary speed of a drill bit disposed at a distal end of a drillstring which is rotated mechanically from surface, the apparatus comprising a programmable logic controller configured to:
linearize a lumped one degree of freedom (1DOF) model which accounted for one or more well parameters and drillstring parameters for a desired state, wherein a discrete state space model and an associated output are defined using a discrete equation;
calculate an estimated rotary speed of the drill bit by applying a predict step and an update step to the linearized lumped 1DOF model;
provide a controller input representing a difference between a desired rotary speed and the estimated rotary speed of the drill bit to a controller, wherein the controller comprises a polynomial controller designed based on the lumped 1DOF model; and
adjust the rotary speed of the drill bit utilizing the polynomial controller based on the controller input.

13. The apparatus of claim 12, wherein the polynomial controller is a H_{∞} controller.

14. An apparatus for controlling a rotary speed of a drill bit disposed at a distal end of a drillstring which is rotated mechanically from surface, the apparatus comprising a programmable logic controller configured to:
apply a filter to a lumped one degree of freedom (1DOF) model which accounted for one or more well parameters and drillstring parameters and to an associated output, wherein an estimated rotary speed of the drill bit is calculated by repeating a predict step and an update step to the lumped 1DOF model at each time iteration;
provide a controller input representing a difference between a desired rotary speed and the estimated rotary speed of the drill bit to a H_{∞} controller designed based on the lumped 1DOF model; and
adjust the rotary speed of the drill bit utilizing the H_{∞} controller based on the controller input.

15. The apparatus of claim 14, wherein the filter is one of: a Linearized Kalman Filter (KF), an Extended Kalman Filter (EKF), a Cubature Kalman Filter (CKF) and an Unscented Kalman Filter (UKF).

16. The apparatus of claim 14, wherein the H_{∞} controller is designed utilizing weighted functions defined to consider modelling of a variable frequency drive (VFD) disposed to mechanically rotate the drillstring.

17. The apparatus of claim 14, wherein the H_{∞} controller automatically modifies and tunes control coefficients including gains, weighted functions and well parameters.
